(19) United States
(12) Patent Application Publication
(10) Pub. No.: US 2001/0015372 A1
(43) Pub. Date: Aug. 23, 2001

(54) Apparatus for transferring micro-balls

(75) Inventors: Takumi Yamamoto, Hamamatsu-shi (JP); Kazuhiko Futakami, Hamamatsu-shi (JP); Akira Hatase, Hamamatsu-shi (JP); Nobuaki Takahashi, Tokyo (JP); Naoji Senba, Tokyo (JP); Yuzo Shimada, Tokyo (JP)

Correspondence Address: DANA L. TANGREN, WORKMAN, NYDEGGER & SEELEY, 1000 Eagle Gate Tower, 60 East South Temple, Salt Lake City, UT, 84111, US

(73) Assignee: E .M Co., Ltd.,, Hamamatsu-shi (JP)

(21) Appl. No.: 09/730,183

(22) Filed: Dec. 5, 2000

(30) Foreign Application Priority Data
Dec. 8, 1999 (JP) 11-349347

(51) Int. Cl. B23K 20/14; B23K 35/12; B23K 31/02

(52) U.S. Cl. 228/180.22; 228/41; 228/246

(57) ABSTRACT

An apparatus for transferring micro-balls in accordance with the present invention, includes a suction head in which a plurality of suction pits are open for holding the respective micro-balls, a head holder to which the suction head is detachably coupled, a suction device communicating with a suction chamber in the head holder, for allowing the suction pits to hold the micro-balls by decompressing the interior of the suction chamber, and a holder transporting device to which the head holder is mounted, wherein the holder transporting device are movable between a sucking position at which is placed a pallet on which the micro-balls to be held by the suction pits, a transferring position at which is placed a working object to which the micro-balls held by the suction pits, and a head exchanging position at which the replacement of the suction head is carried out relative to the head holder.

This application is based on Japanese Patent Application No. 11-349347 (1999) filed Dec. 8, 1999, the content of which is incorporated hereinto by reference.

### BACKGROUND OF THE INVENTION

1. Field of the Invention

The present invention relates to an apparatus for transferring micro-balls wherein the micro-balls arranged on a pallet are held by suction and transferred onto a working object on which the micro-balls are to be placed, particularly to such an apparatus suitable for placing solder balls onto a bump forming portion of a printed circuit board coated with flux.

2. Description of the Related Art

When solder balls are placed on a bump forming portion of a semiconductor chip or a printed circuit board coated in advance with flux and then molten to form electrode bumps, it is necessary to precisely position the very small solder balls in the bump forming portion of the semiconductor chip or the circuit board. For example, as disclosed in Japanese Patent Laid-open No. 5-129374, a suction head is used for holding the solder balls by suction, and after the solder balls held by the suction head have been positioned directly above a working object on which they are to be placed, such as a semiconductor chip or a printed circuit board, so that a lower end of the solder ball is brought into contact with a flux in the bump forming portion, the suction is released to transfer the solder balls onto the flux in the bump forming portion.

Recently, a fine patterning of circuits formed on a semiconductor chip or a printed circuit board has been developed. As a result, a diameter of a solder ball used for forming an electrode bump has become increasingly smaller to an order of approximately 0.1 mm.

If such a small solder ball is sucked by a suction head, it emerges from the lower surface of the suction head as little as an amount from about 0.05 mm to about 0.07 mm. On the contrary, a thickness of the flux with which a surface of the working object is coated in advance is as thick as approximately 0.1 mm. When the suction head holding the solder balls by suction descends toward the working object to place the lower ends of the solder balls on the flux under such circumstances, it is very difficult to prevent the lower end of the suction head from touching the flux because a thickness of the flux is considerably large in comparison with a diameter of the solder ball. In addition, when the solder ball is transferred to the flux in the bump forming portion by interrupting the operation of the suction head, the suction still remains in the suction head for the time being even after the interruption of the sucking operation, whereby part of the flux in the bump forming portion is sucked into the suction head. Consequently, this flux might stick to newly sucked solder balls to result in a risk of failure of transferring such solder balls onto the flux in the bump forming portion.

The semiconductor device or the circuit board on which are formed the electrode bumps often has an extremely short product life due to the renewal of specifications or the improvement thereof. Accompanied therewith, positions of the electrode bumps or others might often be changed every time, which requires the re-design of the suction head in accordance therewith. Accordingly, there has been an inconvenience in that a work volume and a cost for the production increase.

### SUMMARY OF THE INVENTION

An object of the present invention is to provide an apparatus for transferring micro-balls, capable of easily cleaning a suction head and of readily changing particulars of the suction head.

The apparatus for transferring micro-balls according to the present invention comprises a suction head in which a plurality of suction pits are open for holding the respective micro-balls by suction, a head holder to which the suction head is detachably coupled, an attachment/detachment means for detachably coupling the suction head to the head holder, a suction chamber formed in the head holder to communicate with the suction pits when the suction head is coupled, a suction means communicating with the suction chamber, for allowing the suction pits to hold the micro-balls by decompressing the interior of the suction chamber, and a holder transporting means to which the head holder is mounted, wherein the holder transporting means are movable between a sucking position at which is placed a pallet on which the micro-balls to be held by the suction pits in the suction head is arranged, a transferring position at which is placed a working object to which the micro-balls held by the suction pits in the suction head is transferred, and a head exchanging position at which the replacement of the suction head is carried out relative to the head holder.

According to the present invention, the suction head held in the head holder moves to a sucking position by the holder transporting means, and holds the micro-balls in the suction pits of the suction head by actuating the suction means, wherein the micro-balls are waiting at the sucking position while being arranged on the pallet. Then, the suction head moves to the transferring position at which the working object is waiting, and the micro-balls are transferred to a predetermined position in the working object. The suction head thus becoming vacant returns again to the sucking position at which micro-balls are sucked from a pallet newly carried in, which micro-balls then move to the transferring position and transferred to a predetermined position in a fresh working object newly carried in.

The micro-balls are sequentially transferred to the working objects in such a manner. If it is necessary to clean the suction head, the suction head held in the head holder moves by the holder transporting means to the head exchanging position at which the suction head to be cleaned is removed from the holder and replaced with a ready cleaned suction head by actuating the attachment/detachment means.

According to the present invention, since the suction head is detachably coupled via the attachment/detachment means to the head holder, it is possible to easily clean the suction head if necessary by moving the head holder to the head exchanging position and removing the suction head therefrom. Similarly, if it is necessary to change particulars of the suction head such as a layout of the suction pits, what is to be done is nothing but detaching the suction head from the head holder and, instead, attaching a newly designed suction head to the head holder, whereby it is possible to suppress the increase in a work volume and/or a production cost necessary therefor to a minimum.

In the apparatus for transferring micro-balls according to the present invention, the attachment/detachment means may include a first sealing surface formed in the head holder to encircle the suction chamber, a second sealing surface formed in the suction head to be in tight contact with the first sealing surface, and a suction means for evacuating a space defined between both the first and second sealing surfaces. Thus, the attachment/detachment between the head holder and the suction head is quickly and easily obtainable.

The apparatus for transferring micro-balls may further comprise a cleaning means for cleaning the used suction head and a head transferring means capable of holding the suction head, wherein the head transferring means is movable between a head transferring position at which the suction head is mutually transferred relative to the cleaning means and the head exchanging position at which the suction head is mutually transferred relative to the holder transporting means. In this case, the head transferring means may have a turntable on which the suction head is placed. Thereby, the cleaning operation of the suction head is facilitated. In addition, it is possible to attach the ready cleaned suction head to the head holder immediately after detaching the suction head to be cleaned from the head holder to prevent the working efficiency from lowering. Especially, when a turntable is provided as a head transferring means, for placing the suction head thereon, the replacement of the suction head relative to the head holder is further enhanced due to the rotation of the turntable.

The suction head may further comprise a passage forming member having passages disposed between the suction chamber of the head holder and the suction pits and communicating with the suction pits, respectively. In this case, the passage forming member may be formed of a porously sintered material. Accordingly, it is possible to conform the suction head to the variation of particulars of the working object solely by changing the layout of the suction pits, whereby the increase in a work volume and/or a production cost therefor is further avoidable.

The micro-ball may be solder balls. In this case, the working object may have a bump forming portion coated with flux on which the solder balls are transferred.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a conceptual view illustrating a construction of one embodiment according to the present invention applied to solder balls for forming electrode bumps;

FIG. 2 is a plan view of FIG. 1;

FIG. 3 is a sectional view of a suction head of the embodiment shown in FIG. 1, located at a sucking position;

FIG. 4 is an enlarged conceptual view of a cleaning device of the embodiment shown in FIG. 1;

FIG. 5 is a sectional view of the suction head of the embodiment shown in FIG. 1 in a state wherein solder balls are held by suction thereof;

FIG. 6 is a sectional view of the suction head of the embodiment shown in FIG. 1 at a transferring position; and

FIG. 7 is a sectional view illustrating a schematic construction of a suction head according to another embodiment of the present invention.

### DETAILED DESCRIPTION OF PREFERRED EMBODIMENTS

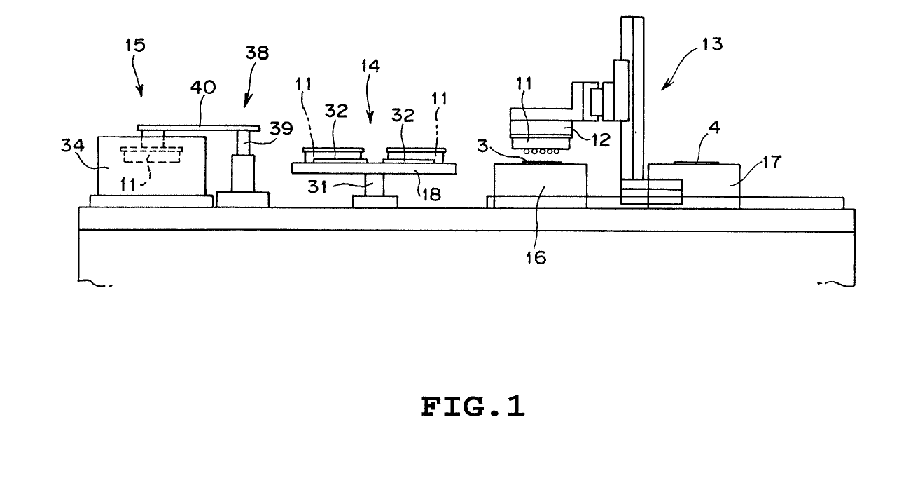

An apparatus for transferring micro-balls according to the present invention will be described in more detail below with reference to the preferred embodiments illustrated in FIGS. 1 to 7, which are applied to solder balls for forming electrode bumps at a predetermined position on a circuit board. The present invention, however, should not be limited to those embodiments, but may include combinations thereof or be applicable to other technologies within a concept of the present invention defined by claims of this specification.

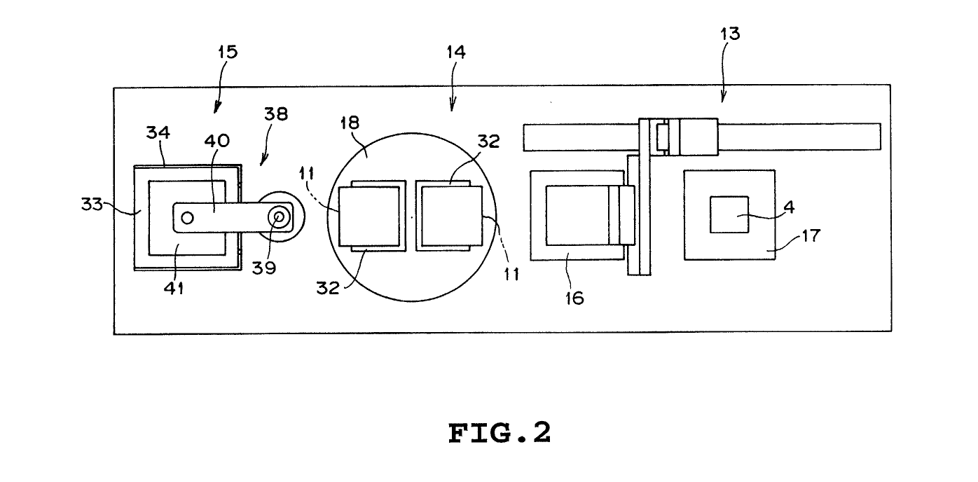

FIG. 1 illustrates a schematic construction of one embodiment according to the present invention, and FIG. 2 is a plan view thereof. That is, the apparatus for transferring micro-balls according to this embodiment includes a suction head 11 capable holding solder balls 1 which are the micro-balls, a head holder 12 detachably holding the suction head 11, a holder transporting device 13 to which the head holder 12 is mounted, a head exchanging device 14 for replacing the suction head 11 relative to the head holder 12, and a head cleaning device 15 for cleaning the suction head 11. The holder transporting device 13 is movable between a pallet table 16 onto which a pallet 3 for holding the solder balls 1 and having conical recesses 2 arranged at a predetermined pattern is placed, a work table 17 onto which a circuit board 4 which is a working object to be transferred is placed, and a turn table 18 in the head exchanging device 14. The head cleaning device 15 and the pallet table 16 are aligned with each other while interposing the turntable 18 in the head exchanging device 14 between the former two. The turntable 18 in the head exchanging device 14 and the work table 17 are aligned with each other while interposing the pallet table 16 between the former two.

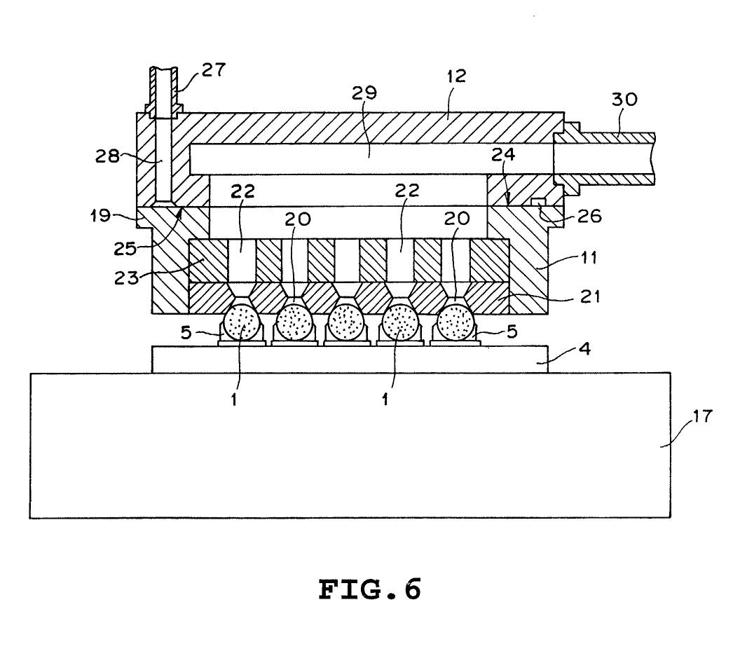

Although not shown, other devices are provided, such as a pallet transporting device for placing the pallet 3 holding the solder balls 1 in the recesses 2, respectively, onto the pallet table 16 and for taking out the empty pallet 3 from the pallet table 16, after the solder balls 1 have been held by suction of the suction head 11, or a circuit board transporting device for placing a circuit board 4, a bump forming portion of which is coated in advance with a flux 5 (see FIG. 6), onto the work table 17 and for taking out the circuit board 4, onto which flux 5 in the bump forming portion are transferred the solder balls 1.

The holder transporting device 13 causes the head holder 12 together with the suction head 11 to be movable forward and backward in the horizontal direction in parallel to the arrangement direction of the head cleaning device 15, the head exchanging device 14, the pallet table 16 and the work table 17, leftward and rightward in the horizontal direction perpendicular to the former, as well as upward and downward in the vertical direction relative to the floor surface. At a sucking position, the holder transporting device 13 holds the solder balls 1 on the pallet 3 placed on the pallet table 16, and at a transferring position, transfers the solder balls 1 onto the flux 5 coated on the bump forming portion in the circuit board 4 placed on the work table 17. Thereafter, at a head exchanging position, the holder transporting device 13 transfers the suction head 11 to be cleaned onto the turn table 18 and instead attaches a fresh suction head 11 to the head holder 12.

While a rectangular coordinates type motion mechanism is used as the holder transporting device 13 in this embodiment, a multi-articulated manipulator or others may be employed.

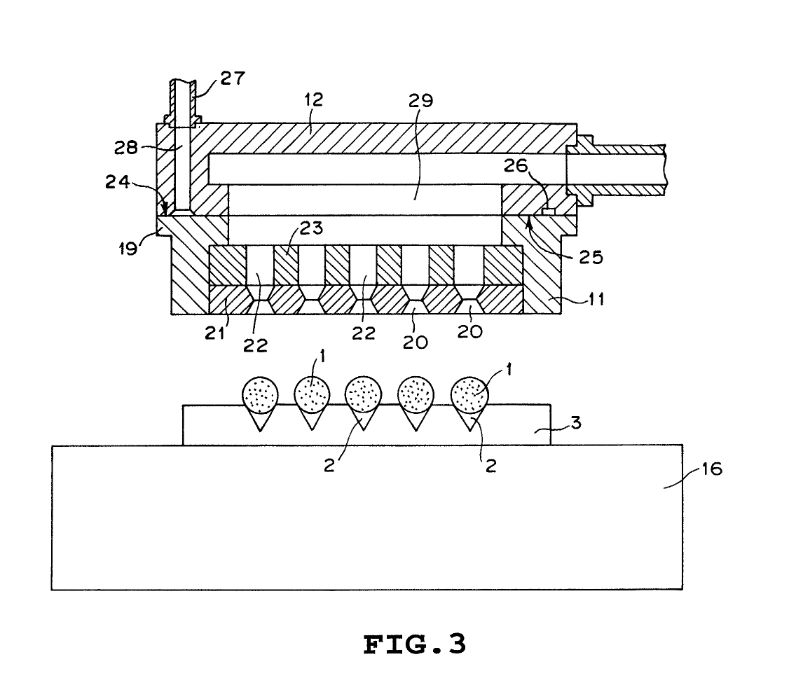

FIG. 3 illustrates an internal structure of the suction head 11 and the head holder 12. That is, the frame-shaped suction head 11 having a flange portion 19 on the outer periphery thereof holds a pit plate 21 in which a plurality of conical-shaped suction pits 20 for holding the solder balls 1 by suction are formed in a predetermined pattern, and a backup plate 23 through which pass a plurality of passages 22 which are communicated with the suction pits 20, respectively, when the backup plate 23 is superposed with the pit plate 21. The pit plate 21 and the backup plate 23 are replaceable with other combinations thereof in accordance with layouts of electrode bumps to be formed in the circuit board 4. The backup plate 23 used as a passage forming member in the present invention is provided for the purpose of preventing the pit plate 21 from being mechanically deformed, which often occurs because the pit plate 21 is formed of a material and/or has a shape poor in rigidity. Accordingly, the backup plate 23 is preferably formed of a ceramic or others having a high mechanical strength.

In the lower end surface of the head holder 12, there is a smooth and flat sealing surface 25 to be in tight contact with another smooth and flat sealing surface 24 formed in the upper end surface of the suction head 11. An annular recess 26 is formed in the sealing surface 25. In addition, a communication passage 28 opens in the recess 26, which communicates with a head vacuum pump not shown via a vacuum piping 27. The sealing surfaces 24, 25, the recess 26, the vacuum piping 27, the head vacuum pump and the communication passage 28 correspond to an attachment/detachment means according to the present invention. That is, when the recess 26 is evacuated by the head vacuum pump while maintaining the tight contact of the sealing surface 25 in the head holder 12 with the sealing surface 24 in the suction head 11, the suction head 11 is held onto the head holder 12 by suction. Contrarily, when the evacuation of the recess 26 is interrupted by stopping the operation of the head vacuum pump, the suction head 11 is detachable from the head holder 12. Such a changeover can be carried out instantaneously.

A suction chamber 29 is provided in the head holder 12, for communicating with the suction pits 20 via the passages 22 when the suction head 11 is coupled to the head holder 12. A ball vacuum pump not shown used as a suction means for holding the solder balls 1 in the suction pits 20 by decompressing the interior of the suction chamber 29 communicates with this suction chamber 29 via a vacuum piping 30. That is, the solder balls 1 can be held in the suction pits 20 by suction when the suction chamber 29 is evacuated by the ball vacuum pump while maintaining the solder balls 1 in tight contact with the suction pits 20 of the suction head 11. On the other hand, if the operation of the ball vacuum pump is interrupted to stop the evacuation of the suction chamber 29, the solder balls 1 are releasable from the suction pits 20.

The turntable 18 in the head exchanging device 14 is rotatable about a vertical rotary shaft 31. There are a pair of positioning frames 32 on the top surface of the turn table 18 at positions apart 180 degrees from each other, for holding the suction heads 11, respectively. A rotational position of the turn table 18 is indexed so that these positioning frames 32 are aligned with the arrangement of the head cleaning device 15, the head exchanging device 14, the pallet table 16 and the work table 17. After the suction head 11 to be cleaned has been transferred from the head holder 12 in the holder transporting device 13 to one positioning frame 32 closer to the pallet table 16, the turn table 18 is made to rotate by 180 degrees to move the other positioning frame 32 carrying a ready-cleaned suction head 11 to a position closer to the pallet table 16, at which the ready-cleaned suction head 11 is mounted to the head holder 12 in the holder transporting device 13.

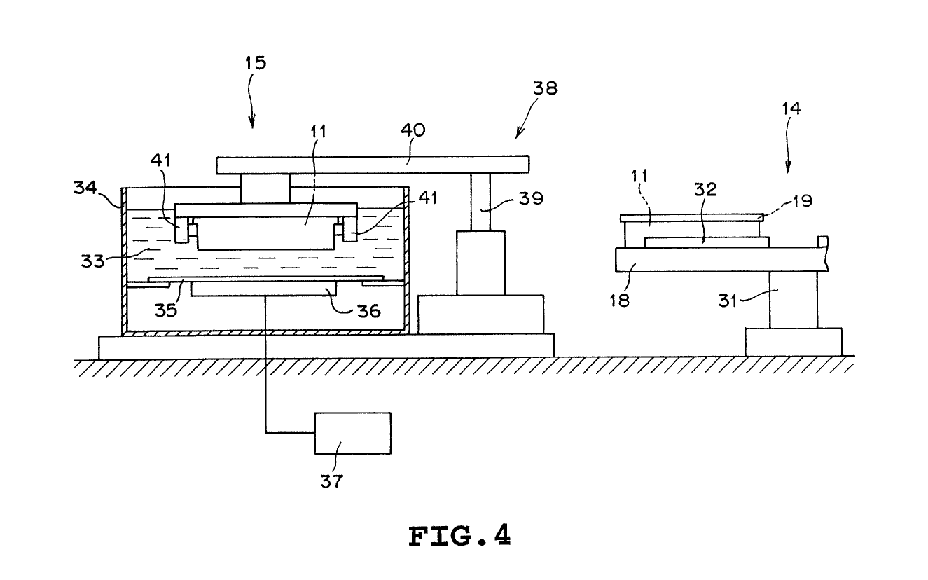

A schematic structure of the head cleaning device 15 is illustrated in FIG. 4 wherein the head cleaning device 15 according to this embodiment includes a cleaning tank 34 filled with a cleaning liquid 33 such as water or solvent, a vibration plate 35 provided on the bottom of the cleaning tank 34, an ultrasonic vibrator 36 attached to the vibration plate 35, an ultrasonic generator 37 connected to the ultrasonic vibrator 36 to oscillate the latter with ultrasonic vibration, and a rotary type manipulator 38 for transferring the suction head 11 between the head exchanging device 14 and the turn table 18.

The manipulator 38 in the head cleaning device 15 is rotatable about a vertical arm shaft 39. The manipulator 38 includes a rotary arm 40 movable upward and downward along an axis of the arm shaft 39, and a head gripper 41 attached to a tip end of the rotary arm 40 and capable of gripping the flange portion 19 of the suction head 11. The manipulator 38 grips, by the head gripper 41, the suction head 11 to be cleaned held in the positioning frame 32 on the turn table 18 at a position closer to the head cleaning device 15, and immerses the same into the cleaning liquid 33 in the cleaning tank 34. The ultrasonic vibration is imparted to the suction head 11 to remove dirt such as flux 5 sticking thereto, and thereafter, the suction head 11 is dried and returned to the positioning frame 32 on the turn table 18 at a position closer to the head cleaning device 15.

While the head cleaning device 15 in this embodiment adopts the ultrasonic cleaning, other cleaning methods than the ultrasonic cleaning may be adopted provided the flux 5 or the like is assuredly removable from the suction head 11.

As described above, the ready-cleaned suction heads 11 are respectively placed on the positioning frames 32 of the turn table 18 in the head exchanging device 14, and the pallet 13 holding the solder balls 1 is placed on the pallet table 16. In this state, the holder transporting device 13 moves to the head exchanging position of the turn table 18 and presses the sealing surface of the head holder 12 onto the sealing surface of the suction head 11. Under the condition, the head vacuum pump not shown is operated to attach the suction head 11 to the head holder 12.

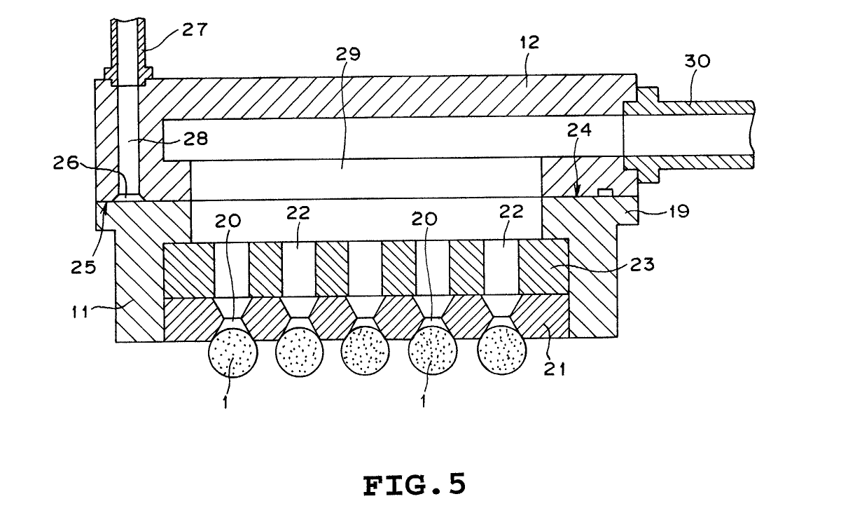

Then, the holder transporting device 13 is operated to carry the suction head 11 to the sucking position, at which the suction head 11 is lowered to the pallet 3 waiting on the pallet table 16 so that the upper end of the respective solder ball 1 placed on the pallet 3 is inserted into the suction pit 20 in the suction head 11. In this state, the ball vacuum pump not shown is operated to evacuate the suction chamber 29, whereby the solder balls 1 on the pallet 3 are held in the suction pits 20 of the suction head 11 (see FIG. 5). Since the interior of the suction chamber 29 is in a decompressed state under the condition, there is no such a problem that the solder balls 1 fall off from the suction pits 20, when the suction head 11 rises from the pallet table 16.

While maintaining this state, the holder transporting device 13 is operated to transport the suction head 11 to the transferring position directly above the circuit board 4 waiting on the work table 17 and lower the suction head 11 toward the circuit board 4 so that the bump forming portion of the latter coincides with the solder balls 1, until the lower end of the respective solder ball 1 is pressed onto the flux 5 coated on the bump forming portion. In this state, the operation of the ball vacuum pump is interrupted to release the solder balls 1 from the suction of the suction pits 20 which are then retreated to a position above the circuit board 4, whereby the solder balls 1 are transferred to the bump forming portion in the circuit board 4 (see FIG. 6).

In this regard, if the solder ball 1 does not fall off from the suction pit 20 even though the operation of the ball vacuum pump is interrupted, air may be supplied into the suction chamber 20 through the vacuum piping 30 and blown out from the suction pits 20 so that the solder balls 1 are assuredly released from the suction pits 20.

When the flux or others is not stuck to the suction head 11, the holder transporting device 13 moves the suction head 11 again to the sucking position at which the above-mentioned steps are repeated. On the contrary, if it is necessary to clean the suction head 11 contaminated with flux 5 or others, the suction head 11 is transported to the head exchanging position. After the suction head 11 to be cleaned is placed onto the positioning frame 32 of the turn table 18, the turn table 18 is made to rotate by 180 degrees to bring the ready-cleaned suction head 11 to the head exchanging position, which suction head 11 is mounted to the head holder 12 to prepare for the above-mentioned steps. In the meanwhile, the suction head 11 to be cleaned is subjected to the ultrasonic cleaning in the head cleaning device 15, after which the suction head 11 thus cleaned is placed on the turn table 18 of the head exchanging device 14 and waiting for the next operation.

While the backup plate 23 for the suction head 11 has a plurality of passages 22 in correspondence to the suction pits 20, respectively, in the above embodiment, it may be replaced with a porously sintered material.

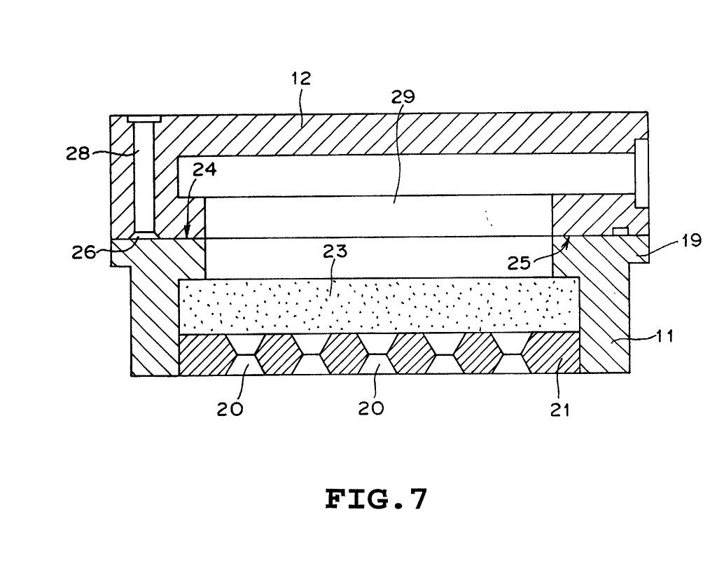

A sectional shape of another embodiment of the present invention having such a suction head 11 is shown in FIG. 7 wherein the same reference numerals are used for denoting the same or similar elements as in the preceding embodiment and the explanation there of will be eliminated. According to this embodiment, the backup plate 23 is formed of an open cell type porously sintered material. Thereby, it is unnecessary to provide the passages 22 in the backup plate 23 in correspondence to the layout of the suction pits 20 as in the preceding embodiment, which is advantageous in that the backup plate 23 can be extremely easily manufactured and machined, and used as it is even though the layout of the suction pits 20 is changed.

The present invention has been described in detail with respect to preferred embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

What is claimed is:

1. An apparatus for transferring micro-balls, comprising
a suction head in which a plurality of suction pits are open for holding the respective micro-balls by suction,
a head holder to which said suction head is detachably coupled,
an attachment/detachment means for detachably coupling said suction head to said head holder,
a suction chamber formed in said head holder to communicate with said suction pits when said suction head is coupled,
a suction means communicating with said suction chamber, for allowing said suction pits to hold the micro-balls by decompressing the interior of said suction chamber, and
a holder transporting means to which said head holder is mounted;
wherein said holder transporting means are movable between a sucking position at which is placed a pallet on which the micro-balls to be held by said suction pits in said suction head is arranged, a transferring position at which is placed a working object to which the micro-balls held by said suction pits in said suction head is transferred, and a head exchanging position at which the replacement of said suction head is carried out relative to said head holder.

2. An apparatus for transferring micro-balls as claimed in claim 1, wherein said attachment/detachment means comprises a first sealing surface formed in said head holder for encircling said suction chamber, a second sealing surface formed in said suction head to be in tight contact with said first sealing surface, and a vacuum means for evacuating a space defined between both said first and second sealing surfaces.

3. An apparatus for transferring micro-balls as claimed in claim 1, wherein the apparatus further comprises a cleaning means for cleaning the used suction head and a head transferring means capable of holding said suction head,
wherein said head transferring means is movable between a head transferring position at which said suction head is mutually transferred relative to said cleaning means and the head exchanging position at which said suction head is mutually transferred relative to said holder transporting means.

4. An apparatus for transferring micro-balls as claimed in claim 3, wherein said head transferring means has a turntable on which said suction head is placed.

5. An apparatus for transferring micro-balls as claimed in claim 1, wherein said suction head further comprises a passage forming member having passages disposed between said suction chamber of said head holder and said suction pits and communicating with said suction pits, respectively.

6. An apparatus for transferring micro-balls as claimed in claim 5, wherein said passage forming member is formed of a porously sintered material.

7. An apparatus for transferring micro-balls as claimed in claim 1, wherein the micro-balls are solder balls.

8. An apparatus for transferring micro-balls as claimed in claim 7, wherein the working object has a bump forming portion coated with flux on which the solder balls are transferred.
